(19) United States
(12) Patent Application Publication
(10) Pub. No.: US 2026/0091793 A1
(43) Pub. Date: Apr. 2, 2026

(54) DYNAMIC ADJUSTMENT OF ECU CALIBATIONS

(71) Applicant: Cummins Inc., Columbus, IN (US)

(72) Inventors: Scott G. Decker, Columbus, IN (US); Amol Arunrao Solanke, Milton Keynes (GB); Jesus Salvador Almanza Garcia, Rochester Hills, MI (US)

(21) Appl. No.: 18/901,024

(22) Filed: Sep. 30, 2024

(51) Int. Cl. B60W 50/06

(52) U.S. Cl. CPC B60W 50/06

(57) ABSTRACT

A process includes first operating an ECU to control operation of the powertrain system including executing by a processor a control operation using a first value of a first calibration stored in the nonvolatile core memory and a first run time value stored in a volatile core memory, receiving via an interface a tuning message including a tuning value directed to the first value of the first calibration parameter stored in the nonvolatile core memory, the tuning value differing from the first value, redirecting the tuning value to be stored in a volatile memory, and second operating the ECU to control operation of the powertrain system, the second operating including second executing by the processor the control operation using the tuning value stored in the volatile memory and a second run time value stored in the volatile core memory.

### TECHNICAL FIELD

The present application relates to dynamic adjustment of electronic control unit (ECU) calibrations and related apparatuses, systems, and processes.

### BACKGROUND

Powertrain system may utilize electronic control units configured with calibrations that can be adjusted or tuned to affect operation of the powertrain system. Existing approaches to such calibration adjustment or tuning suffer from a number of disadvantages, shortcomings, and unmet needs including those respecting, complexity, efficiency, flexibility, and useability among others. Such disadvantages, shortcomings, and unmet needs may be particularly acute for multi-core processor architectures as well as single core architectures There remains a significant need for the unique apparatuses, processes, and systems disclosed herein.

### Disclosure of Example Embodiments

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY OF THE DISCLOSURE

Some embodiments include unique apparatuses including dynamic adjustment of electronic control unit (ECU) calibrations. Some embodiments include unique processes including dynamic adjustment of electronic control unit (ECU) calibrations. Some embodiments include unique systems including dynamic adjustment of electronic control unit (ECU) calibrations. Further embodiments, forms, objects, features, advantages, aspects, and benefits shall become apparent from the following description and drawings.

### BRIEF DESCRIPTION OF THE DRAWINGS

FIG. 1 is a schematic diagram depicting certain aspects of an example machine system.

FIGS. 2A-2C are schematic diagrams depicting certain aspects of an example electronic control unit in several operational states.

FIG. 3 is a schematic diagram depicting certain aspects of an example operation of an electronic control system.

FIG. 4 is a schematic diagram depicting certain aspects of an example operation of an electronic control system.

FIG. 5 is a schematic diagram depicting certain aspects of an example operation of an electronic control system.

FIG. 6 is a schematic diagram depicting certain aspects of an example operation of an electronic control system.

FIGS. 7-9 are a flow diagrams depicting certain aspects of an example process.

### DETAILED DESCRIPTION OF EXAMPLE EMBODIMENTS

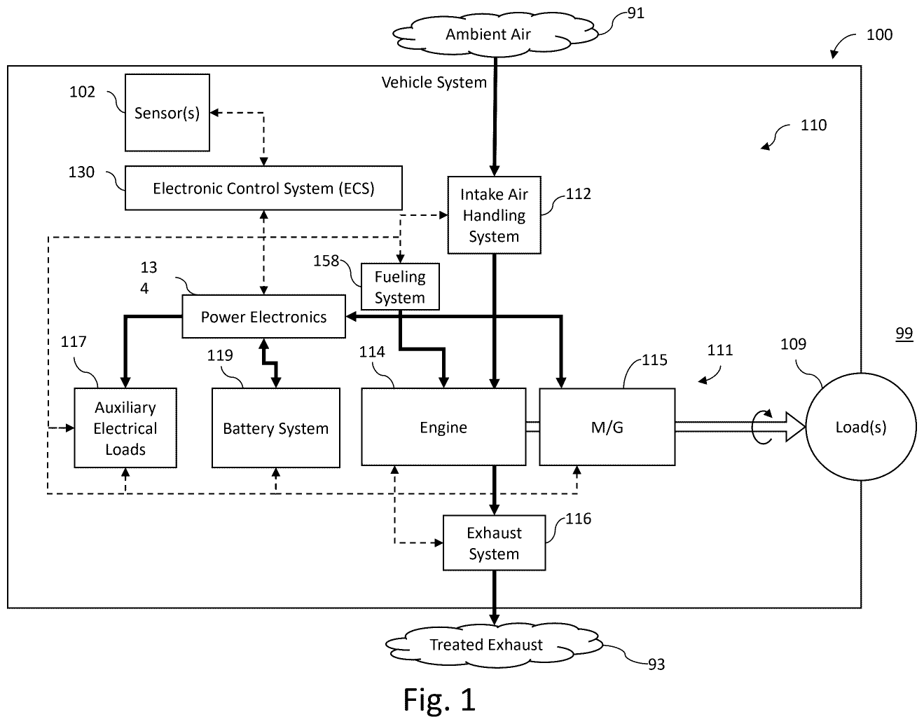

With reference to FIG. 1, there is illustrated an example machine system 100 including a powertrain system 110 (also referred to herein as system 110) including a prime mover system 111 configured to drive one or more loads 109. Machine system 100 may be configured and provided in a number of forms. In the illustrated embodiment, machine system 100 is configured and provide in the form of a vehicle system, for example, an on-highway vehicle or an off-highway vehicle system. While machine system 100 is illustrated and described in the context of a vehicle system, it shall be appreciated that the present disclosure contemplates used in a variety of other systems. In other embodiments, for example, machine system 100 may be configured and provided in the form of a work machine or work machine powertrain system, a genset or genset powertrain system, or a hydraulic fracturing rig or hydraulic fracturing rig powertrain system, to name several non-limiting examples. It shall be appreciated that machine system 100 may include a number of other components in addition to or as alternatives to the illustrated components as will occur to one of skill in the art with the benefit and insight of the present disclosure.

System 110 and prime mover system 111 may be configured and provided in a number of forms. In the illustrated example, system 110 and prime mover system 111 are configured and provided in a hybrid combustion-electric form including an internal combustion engine 114 and associated intake air handling system 112, exhaust system 116, and fueling system 158, and also including motor/generator (M/G) 115 and associated battery system 119 and power electronics 134. In other example embodiments, system 110 and prime mover system may be configured and provided as another type of prime mover system such as, for example, powertrains comprising battery electric prime mover systems, traction motor prime mover systems, fuel cell prime mover system, or other forms of powertrain and prime mover system as will occur to one of skill in the art with the benefit and insight of the present disclosure. In some such embodiments, internal combustion engine 114 and associated intake air handling system 112, exhaust system 116, and fueling system 158 may be omitted and the prime mover system pay be configured and provided in a battery electric form. It shall also be appreciated that system 110 may include a number of other components which are not depicted herein such as transmission systems and components, engine accessories, and other systems and components as will occur to one of skill in the art with the benefit and insight of the present disclosure.

In the illustrated embodiment, engine 114 is configured and provided in a four-stroke, compression ignition form. It shall be appreciated that engine 114 may be provided in a number of forms including spark ignition and liquid-spark ignition forms. Furthermore, in various forms, engine 114 may be configured for combustion of a number of fuels including, for example, diesel fuel, gasoline, natural gas, other gaseous hydrocarbons, hydrogen, alcohols, or other fuels or combinations of fuels as will occur to one of skill in the art with the benefit and insight of the present disclosure. Typical forms of engine 114 may include a block including a plurality of cylinders and a head coupled with the block. The head typically includes intake ports, intake valves configured to selectively open and close the intake ports, exhaust ports, exhaust valves configured to selectively open and close the exhaust ports, injector bores, fuel injectors disposed in the injector bores, spark plug bores, and spark plugs disposed in the spark plug bores. A plurality of pistons may be provided in respective ones of the plurality of cylinders. A crankshaft may be coupled with the plurality of pistons and configured to translate reciprocating motion of the plurality of pistons to provide torque for driving the one or more loads 109 which may include internal loads of system 110 (such oil pumps, valvetrains, fuel pumps and other loads of engine 114, and accessory loads of system 110). It shall be appreciated that system 110 may include a number of other components as will occur to one of skill in the art with the benefit and insight of the present disclosure.

Intake air handling system 112 may include one or more air handling conduits, air filters, compressors (such as a compressor of a turbocharger or supercharger), coolers (such as charger air coolers, intercoolers, and/or aftercoolers which may be, for example, of an air-to-air type or an air-to-liquid type), and sensors (such as temperature sensors, pressure sensors, mass flow sensors, and other types of sensors), as well as other components.

Exhaust system 116 may include one or more exhaust handling conduits, turbines (such as a turbine of a turbocharger), aftertreatment components (such as oxidation catalysts, particular filters, selective catalytic reduction (SCR) catalysts, and/or other catalysts and aftertreatment components), and sensors (such as temperature sensors, pressure sensors, oxygen or lambda sensors, mass flow sensors, and other types of sensors), as well as other components.

Fueling system 158 may be configured and provided as a high-pressure common-rail fuel injection system including a plurality of fuel injectors in fluid communication with a common fuel rail, which supplies fuel at relatively high pressure to the plurality of fuel injectors. Fuel may be supplied to the common fuel rail by a high-pressure pump which, in turn, may be fed by a relatively low-pressure fuel circuit including a booster pump, which may be immersed in a tank containing a reservoir of fuel.

In the illustrated embodiment, system 110 and prime mover system 111 are configured and provided in a parallel hybrid form in which motor/generator 115 can operate as a motor a powered by electricity from battery system 119 via power electronics 134 to output torque to drive loads either alone or in combination with torque output by engine 114, or as an electric generator driven by torque from engine 114 or regenerative braking, to generate and provide power via power electronics 134 to charge battery system 119.

In the illustrated embodiment, battery system 119 is configured and operable to output power via power electronics 134 to selectively power and drive either or both of motor/generator 115 and auxiliary electrical loads 117. Auxiliary electrical loads 117 may comprise any or a number of electrified vehicle loads including, for example, electrified fans, pumps, compressors, or other loads as will occur to one of skill in the art with the benefit and insight of the present disclosure.

System 110 includes an electronic control system (ECS) 130 which preferably includes one or more programmable microcontrollers of a solid-state, integrated circuit type, and one or more non-transitory memory media configured to store instructions executable by the one or more microcontrollers. For purposes of the present application the term microcontroller shall be understood to also encompass microprocessors and other types of integrated circuit processors. ECS 130 is in operative communication with and may be adapted and configured to control operation of and/or receive inputs from sensors or controllers of intake air handling system 112, engine 114, exhaust system 116, and fueling system 158. ECS 130 is in operative communication with and may be adapted and configured to control operation of and/or receive inputs from one or more system sensors 102 of machine system 100 which may include, for example, a throttle position sensor or an accelerator position sensor. It shall be appreciated that FIG. 1 depicts control relationships between the foregoing components conceptually using dashed arrows and that various communications hardware and protocols may be utilized to implement, such as one or more controller area networks (CAN) or other communications components.

ECS 130 can be implemented in any of a number of ways that combine or distribute the control function across one or more control units in various manners. The ECS 130 may execute operating logic that defines various control, management, and/or regulation functions. This operating logic may be in the form of dedicated hardware, such as a hardwired state machine, analog calculating machine, programming instructions, and/or a different form as would occur to those skilled in the art. The ECS 130 may be provided as a single component or a collection of operatively coupled components; and may be comprised of digital circuitry, analog circuitry, or a hybrid combination of both of these types. When of a multi-component form, the ECS 130 may have one or more components remotely located relative to the others in a distributed arrangement. The ECS 130 can include multiple processing units arranged to operate independently, in a pipeline processing arrangement, in a parallel processing arrangement, or the like. It shall be further appreciated that the ECS 130 and/or any of its constituent components may include one or more signal conditioners, modulators, demodulators, Arithmetic Logic Units (ALUs), Central Processing Units (CPUs), limiters, oscillators, control clocks, amplifiers, signal conditioners, filters, format converters, communication ports, clamps, delay devices, memory devices, Analog to Digital (A/D) converters, Digital to Analog (D/A) converters, and/or different circuitry or components as would occur to those skilled in the art to perform the desired communications.

An operating environment 99 is also depicted in FIG. 1. As described above, during typical operation of machine system 100, ambient air 91 of operating environment 99 is received as an input to machine system 100, and treated exhaust 93 from machine system 100 is released to operating environment 99. In some embodiments, the one or more loads 109 may at least in part comprise a portion of operating environment 99. For example, in embodiments where machine system 100 is provided in the form of a genset or genset powertrain system, the one or more loads 109 may comprise loads at various nodes in a distributed power network in addition to load components which, even if small, are integral to machine system 100. As another example, in embodiments where machine system 100 is provided in the form of a vehicle or vehicle powertrain system, the one or more loads 109 may include forces such as wind, gravity, road surface friction and other environmental load components in addition to load components which, even if small, are integral to machine system 100.

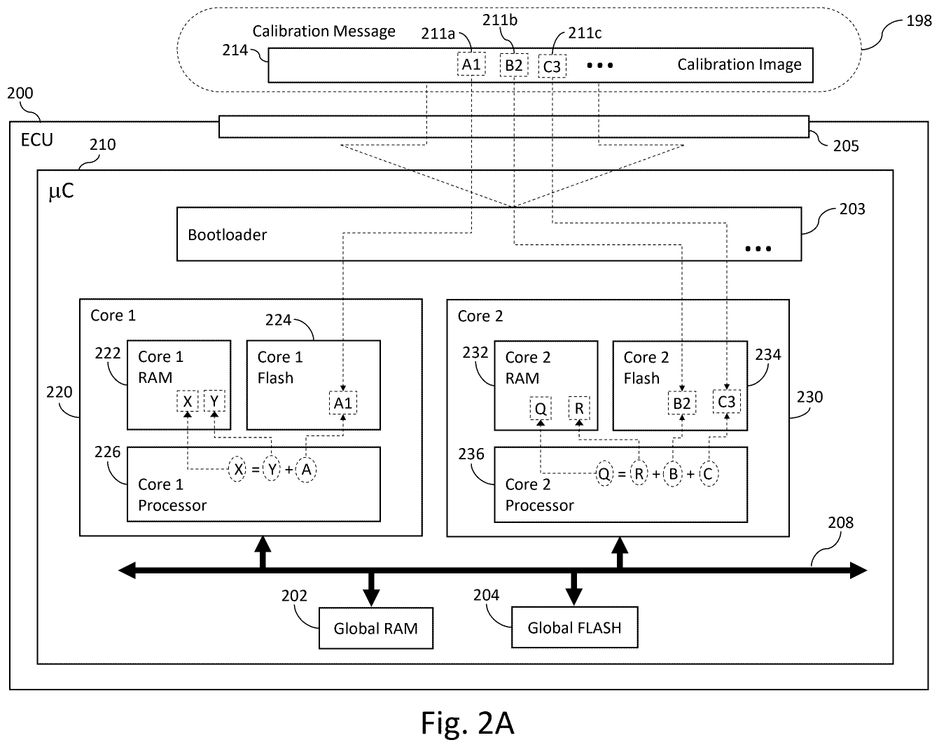

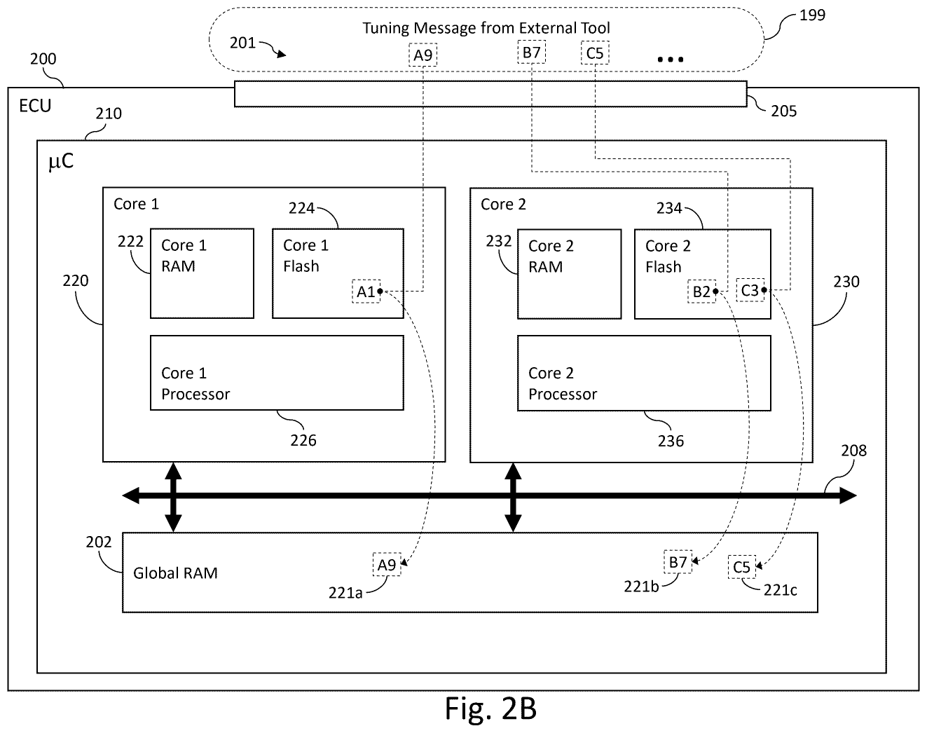

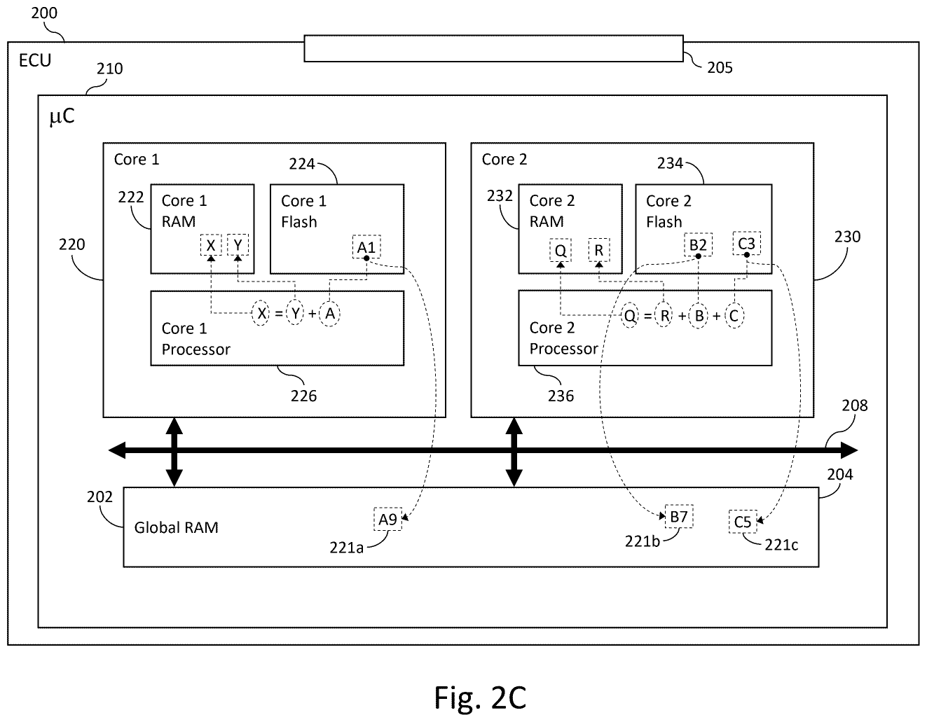

With reference to FIGS. 2A-2C there is illustrated an example electronic control unit (ECU) 200 which may be provided as a component of ECS 130 or another electronic control system according to the present disclosure. ECU 200 includes microcontroller 210 which is operatively coupled with interface 205 of ECU 200 and which may also be operatively coupled with other components of ECU 200. In the illustrated example, microcontroller 210 is provided in a multi-core form including core 220 and core 230. Other embodiments may comprise microcontrollers with different numbers of cores, for example, single-core microcontrollers, or multi-core microcontrollers with differing numbers of cores.

Microcontroller 210 includes non-transitory controller readable memory media in the form of global random access memory (global RAM) 202 and global Flash memory 204. Global RAM 202 is an example of ECU volatile memory which may be accessed by and utilized by multiple components of microcontroller 210 including, for example, core 220 and core 230. Other embodiments may utilize other types and configurations of global volatile memory. Global Flash memory 204 is one example of global nonvolatile memory which may be accessed by and utilized by multiple components of microcontroller 210 including, for example, core 220 and core 230. Other embodiments may utilize other types and configurations of global nonvolatile memory. In the illustrated example global RAM 202 and global Flash memory are configured and provided as integral components of microcontroller 210, for example, components formed and provided on the same integrated circuit chip or die. Other embodiments may additionally or alternatively utilize global RAM (or other global volatile memory) and global Flash memory (or other global nonvolatile memory) that are external to and in operative communication with a microcontroller via one or more communication busses or other communication links.

Microcontroller 210 includes one or more communication buses 208 which are operatively coupled with global RAM 202, global Flash memory 204, core 220, core 230, and potentially other components of microcontroller 210. The one or more communication busses 208 are configured and operable to provide communication links between such operatively coupled components. It shall be appreciated that one or more communication buses 208 may comprise various forms and arrangements of communication links and interconnections as will occur to one of skill in the art with the benefit and insight of the present disclosure.

Interface 205 is configured to provide operative communication with a tool external to ECU 200, such as a calibration computer operatively coupled with machine system 100 and ECU 200. Interface 205 may receive a calibration messages, such as tuning message 199, from the external tool which is provided to and received by microcontroller 210. Such calibration messages may include one or more values for one or more calibration parameters stored in calibration image 214 of global Flash memory 204.

As illustrated in FIG. 2A, a calibration message 198 from an external calibration tool may be received by ECU 200 and microcontroller 210 via interface 205. Calibration image 214 comprises a plurality of calibration parameters. It shall be appreciated that a given calibration parameter (for example, a fueling trim parameter) may have a number of different values representing different calibrations of the given calibration parameter (for example, different magnitudes of the fueling trim). Calibration image 214 may comprise multiple pages containing respective sets of the calibration parameters. For example, the calibration parameters at locations 211a, 211b, and 211c may be located on a single page of calibration image 214 or of different pages of calibration image 214. In the context of Flash memory, it shall be appreciated that a page refers to the smallest unit of memory that can be programmed or written to, it being appreciated that other global nonvolatile memory may comprise smallest programmable or writable units having other nomenclature.

Calibration messages generally refer to messages from a calibration tool that include one or more values for one or more calibration parameters that may be received and stored by an electronic control system and utilized in providing or modifying calibrations stored by the electronic control system. Calibration messages may be of several types. Some calibration messages, such as calibration message 198, may be configured and operable to provide calibration image 214 (or a portion thereof) to bootloader 203 which, in turn, loads one or more portions of the calibration image to flash memory (or other nonvolatile memory). Such calibration messages may write or overwrite all of the values of the calibration parameters on a given page. Such calibration parameters may be utilized by other components of microcontroller such as microcontroller 210 to perform control operations in combination with run time parameters.

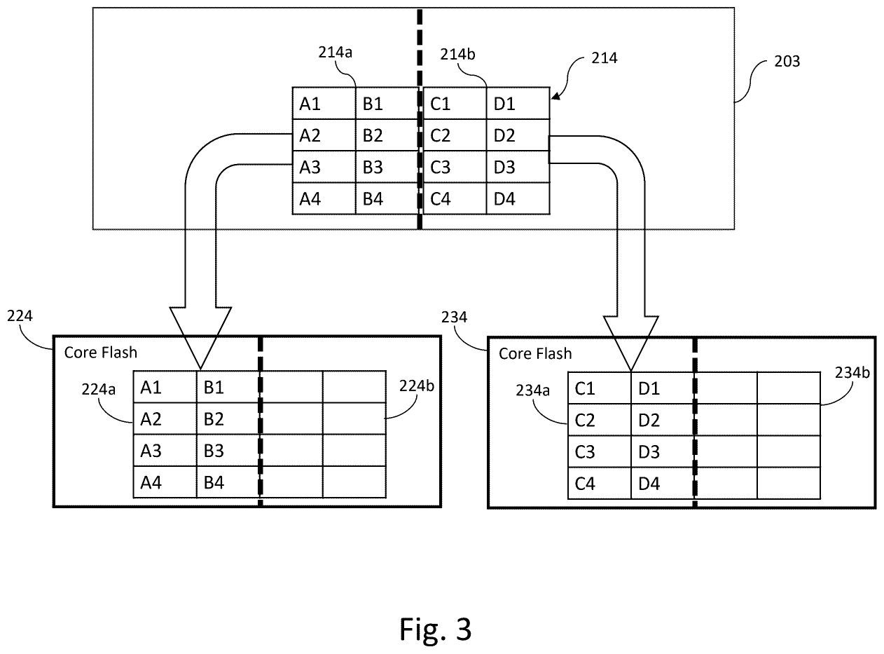

FIG. 3 illustrates example operations of bootloader 203. Bootloader 203 performs a load operation in which a first page 214a of calibration image 214 is loaded and written to a first page 224a of core Flash memory 224, while a second page 224b of core Flash memory 224 is not written or overwritten. Bootloader 203 also performs a load operation in which operation in which a first page 214b of calibration image 214 is loaded and written to a first page 234a of core Flash memory 234, while a second page 234b of core Flash memory 234 is not written or overwritten.

With additional reference to FIG. 2B, some calibration messages comprise tuning messages, such as tuning message 199, which comprise values of individual calibration parameters which may be addressed to different pages of calibration image 214 or to a single page of calibration image 214, depending on the particular calibration parameters addressed by tuning message 199, and which in either case may comprise fewer than the total number of calibration parameters of a given page of calibration image 214 or less than a full page (or other smallest programmable or writable unit) of calibration image 214. Such tuning messages are configured and operable to effectively replace or substitute values of individual calibration parameters of calibration image 214 without requiring writing or overwriting any page or pages of calibration image 214. Such replacement values, in turn, may be utilized by other components of a microcontroller such as microcontroller 210 to perform control operations and may achieve the same net control effect as would be realized by writing or overwriting a page or pages of calibration image 214 with corresponding parameters.

It shall be appreciated that tuning messages, such as tuning message 199, may be utilized in calibration discovery processes in which correct or optimal values for one or more calibration parameters are determined while a system undergoing calibration is on-line and operating. Such calibration discovery and value determination processes may utilize multiple tuning messages to repeatedly vary the values of one or more calibration parameters while the system is on-line and operating. The varied values need not be saved to a calibration image stored in a nonvolatile memory such as flash memory while the system is on-line and operating. Instead, correct or optimal values for one mor more calibration parameters may be written to a nonvolatile memory such as flash in a subsequent calibration operation in which the system is off-line and not operating. In other embodiments, where such operations are permitted and desired, correct or optimal values for one mor more calibration parameters may be saved to a calibration image stored in a nonvolatile memory such as flash memory while the system is on-line and operating.

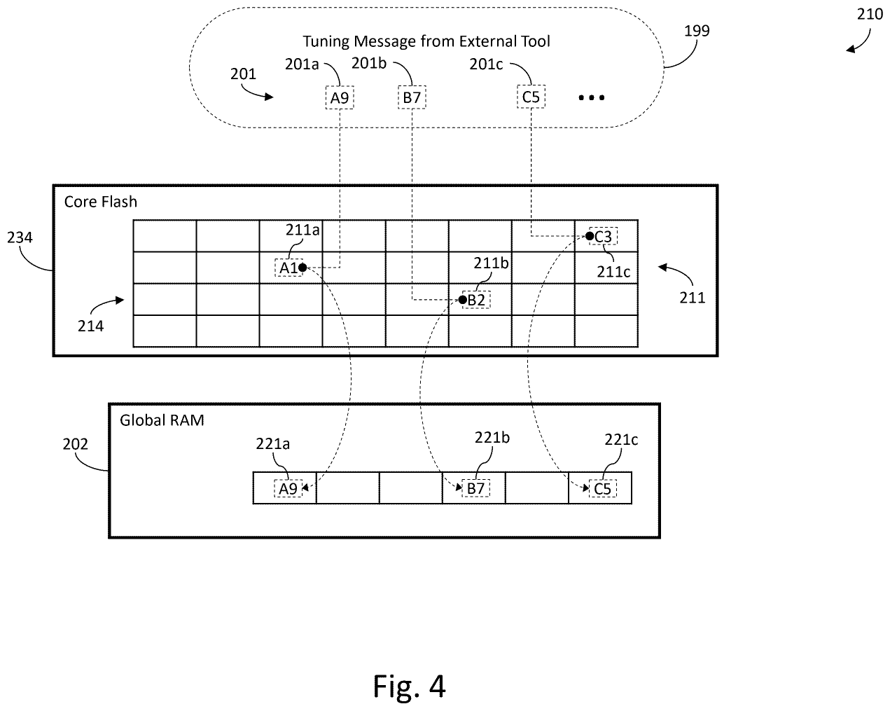

As illustrated in FIG. 2B and FIG. 4, tuning message 199 includes a plurality of tuning values 201 which are directed to respective values of respective calibration parameters stored in core flash 224 and core Flash memory 234 which are configured to store calibration image 214 or a portion thereof. Tuning values 201 may be so directed using physical addresses, linear addresses, logical addresses, virtual addresses, or other addressing, pointers, prefixing, and other addressing or directing techniques as will be appreciated by one of skill in the art with the benefit and insight of the present disclosure. Each of the respective locations 211 correspond to a respective one of a plurality of calibration parameters utilized by microcontroller 210 in executing operations to control operation of a system including ECU 200, for example, prime mover system 111, other components of powertrain system 110, and/or other components of machine system 100. More particularly, as illustrated in FIG. 4, the plurality of tuning values 201 include tuning values 201a, 201b, and 201c which are addressed to locations 211a, 211b, and 211c of the plurality of locations 211 which, in turn, each correspond to a respective calibration parameter of the calibration image 214.

Microcontroller 210 may respond to a tuning message, such as tuning message 199, by redirecting one or more tuning values addressed to respective locations of calibration image 214 to respective locations of global RAM 202. A processor core of the microcontrollers, such as core 220 and/or core 230, may obtain modified execution parameters including at least a first one of the one or more tuning values of global RAM 202. The processor core of the microcontrollers may then execute one or more operations to control operation of the powertrain system using the modified execution parameters.

In the illustrated examples of FIG. 2B and FIG. 4, microcontroller 210 is configured and operable, in response to tuning message 199, to redirect the value (A9) of tuning value 201a which is addressed to location 211a of calibration image 214 (illustrated as storing the value A1) to a location 221a of global RAM 202 which receives such redirection and stores the value (A9) of tuning value 201a at location 221a. Microcontroller 210 may similarly redirect the value (B7) of tuning value 201b which is addressed to location 211b of calibration image 214 (storing the value B2) to a location 221b of global RAM 202 which receives such redirection and stores the value (B7) of tuning value 201b in location 221b. Microcontroller 210 may similarly redirects the value of tuning value 201c (C3) which is addressed to location 211c of calibration image 214 (storing the value C5) to a location 221c of global RAM 202 which stores the value (C3) of tuning value 201c in location 221c.

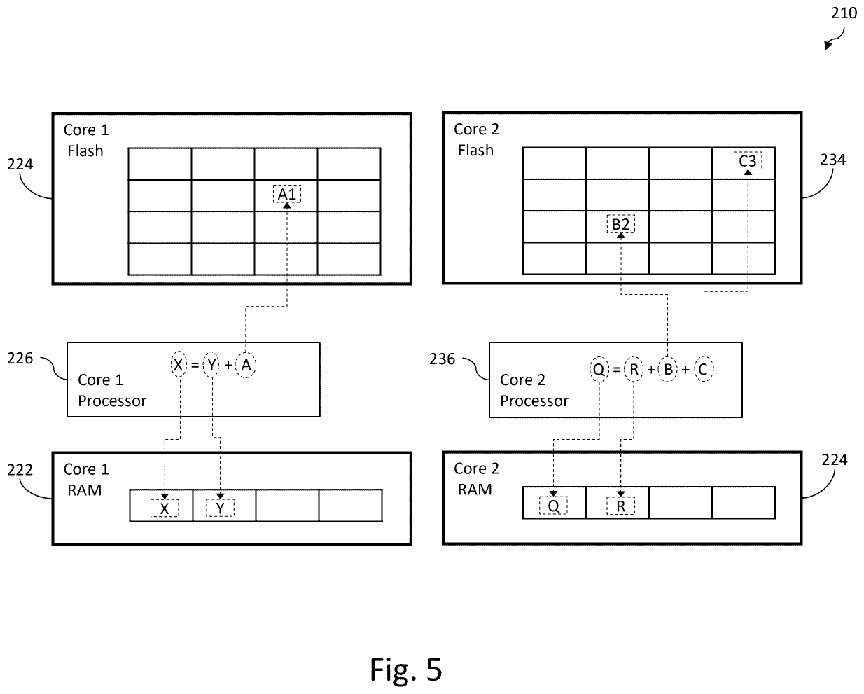

Core 220 includes a processor 226, core RAM 222, and core Flash memory 224 which are operatively coupled with one another. Core 230 includes a processor 236, core RAM 232, and core Flash memory 234 which are operatively coupled with one another. As illustrated in FIG. 5, in some operations, processor 226 may execute a control operation (represented by the equation X=Y+A as a simplified example) to determine a run time variable value X in response to run time variable value Y stored in core RAM 222 and calibration parameter value A1 stored in core Flash memory 224 and the resulting run time variable value X may be stored in core RAM 222. Similarly, in some operations, processor 236 may execute a control operation (represented by the equation Q=R+B+C as a simplified example) to determine a run time variable value Q in response to run time variable value R stored in core RAM 222 and calibration parameter value A1 stored in core Flash memory 224 and the resulting run time variable value X may be stored in core RAM 222.

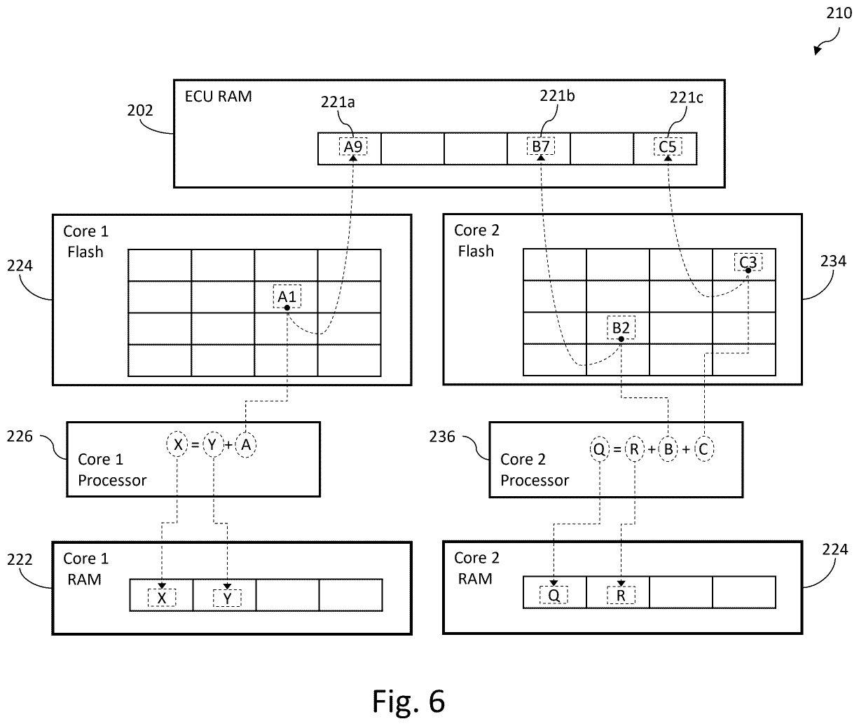

As further illustrated in FIG. 2C and FIG. 6, processor cores, such as core 220 and/or core 230, may also operate, in response to tuning message 199 and/or the aforementioned redirection of values, to obtain and utilize one or more values stored in global RAM 202 to control operation of operation of a system including ECU 200, for example, prime mover system 111, other components of powertrain system 110, and/or other components of machine system 100. In response to tuning message 199 (or as a further response to the aforementioned redirection of values to global RAM 202), microcontroller 210 is configured and operable to execute other operations to determine a value of run time variables using the calibration parameter values stored in global RAM 202.

Processor 226 may execute a control operation (represented by the equation X=Y+A as a simplified example) to determine run time variable value X in response to run time variable value Y stored in core RAM 222 and calibration parameter value A9 stored in location 221a of global RAM 202 and the resulting run time variable value X may be stored in core RAM 222. In such operation, a request by processor 226 for the value of a calibration parameter stored in core Flash memory 224 is redirected to obtain and provide the calibration parameter value (A9) stored in location 221a of global RAM 202. Accordingly, processor 226 may determine run time variable value X in response to execution parameters modified relative to the example illustrated and described in connection with FIG. 5, and such modified parameters may include one or more tuning values of stored in global RAM 202.

Processor 236 may execute a control operation (represented by the equation Q=R+B+C as a simplified example) to determine run time variable value Q in response to run time variable value R stored in core RAM 222, calibration parameter value B7 stored in location 221b of global RAM 202, and calibration parameter value C5 stored in location 221c of global RAM 202, and the resulting run time variable value X may be stored in core RAM 222. In such operations, a first request by processor 236 for the value of a calibration parameter value stored in core Flash memory 234 may be redirected to obtain the calibration parameter value (B7) stored in location 221b of global RAM 202, and a second request by processor 236 for the value of a calibration parameter value stored in core Flash memory 224 may be redirected to obtain the calibration parameter value (C5) stored in location 221b of global RAM 202. Accordingly, processor 236 may determine run time variable value Q in response to execution parameters modified relative to the example illustrated and described in connection with FIG. 5, and such modified parameters may include one or more tuning values of stored in global RAM 202.

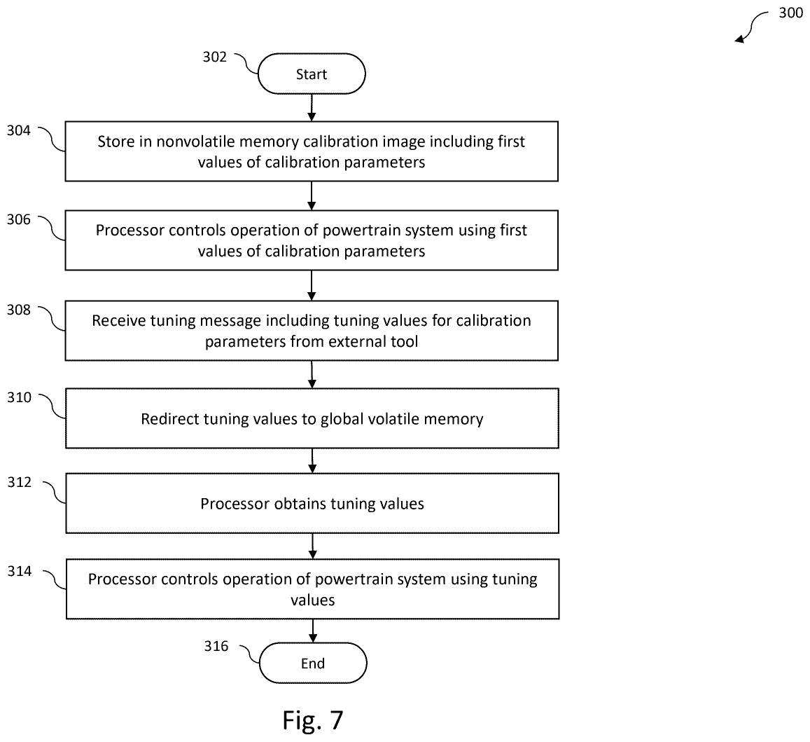

With reference to FIG. 7, there is illustrated an example process 300 which may be performed during operation of microcontroller 210 or another microcontroller according to the present disclosure.

Process 300 begins at start operation 302 and proceeds to operation 304. At operation 304, a microcontroller has stored in a nonvolatile memory a calibration image including first values of one or more calibration parameters.

From operation 304, process 300 proceeds to operation 306 and proceeds to operation 304. At operation 306, a processor core of the microcontrollers of the microcontroller controls operation of powertrain system using the first values of the one or more calibration parameters.

From operation 306, process 300 proceeds to operation 308 and proceeds to operation 304. At operation 308, the microcontroller receives from an external tool external a tuning message including tuning values for one or more calibration parameters. In some embodiments, the microcontroller receives a tuning message from a tool external to the powertrain system, the tuning message including one or more tuning values addressed to respective locations of the calibration image stored in the ECU nonvolatile member corresponding to respective ones of the plurality of calibration parameters. In some embodiment, prior to performing operation 308, a calibration tool may send a list of calibration addresses and sizes it wants to adjust to the microcontroller in advance of sending the tuning message to allow the microcontroller to take appropriate preliminary actions for responding to the tuning message.

From operation 308, process 300 proceeds to operation 310 and proceeds to operation 304. At operation 310, the microcontroller redirects tuning values of the tuning message directed to nonvolatile memory to respective locations of a global volatile memory.

From operation 310, process 300 proceeds to operation 312 and proceeds to operation 304. At operation 312, a processor core of the microcontrollers of the microcontroller obtains modified execution parameters including one or more tuning values stored in the global nonvolatile memory.

From operation 312, process 300 proceeds to operation 314 and proceeds to operation 304. At operation 314, a processor core of the microcontrollers of the microcontroller controls operation of powertrain system using tuning values obtained from the global nonvolatile memory.

From operation 314, process 300 proceeds to end operation 316 and may thereafter repeat or be recalled.

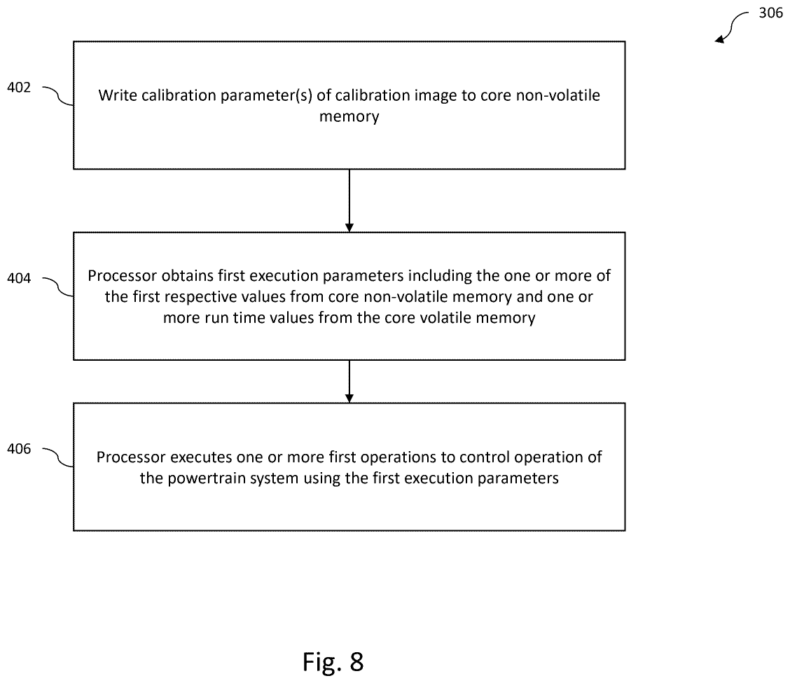

With reference to FIG. 8, there is illustrated an example implementation of operation 306 of process 300. At operation 402 one or more values of the calibration image are written to a core nonvolatile memory, for example, by loading such values using a bootloader. At operation 404, a processor core of the microcontroller obtains first execution parameters including the one or more of the first respective values from the core nonvolatile memory and one or more run time values from the core volatile memory. At operation 406, a processor core of the microcontrollers executes one or more operations to control operation of the powertrain system using the first execution parameters.

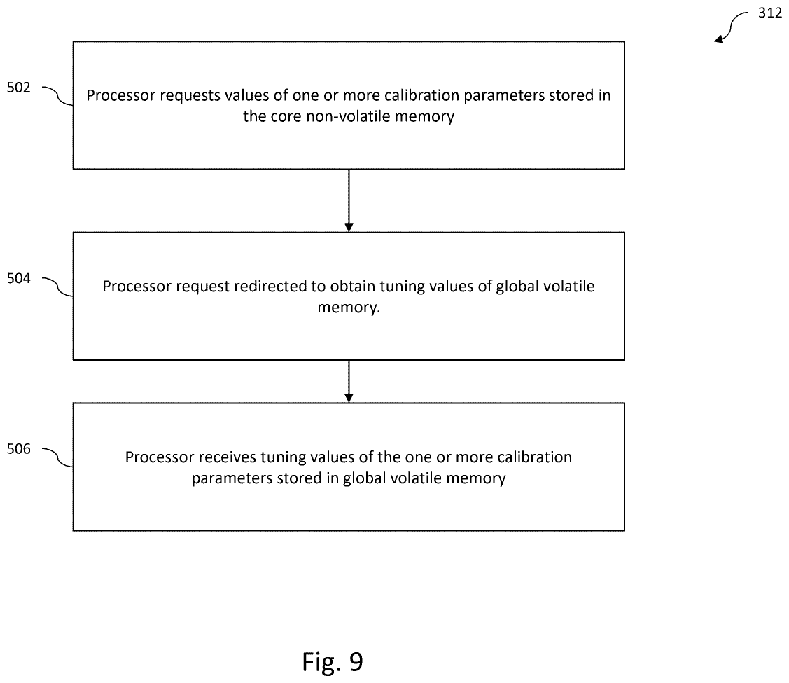

With reference to FIG. 9, there is illustrated an example implementation of operation 312 of process 300. At operation 502, the processor core requests values of one or more calibration parameters stored in the core nonvolatile memory. At operation 504, the processor core request is redirected to obtain tuning values stored in the global volatile memory. At operation 506, the processor core receives the tuning values of the one or more calibration parameters stored in the global volatile memory.

As illustrated by this detailed description, the present disclosure contemplates multiple embodiments including the following example embodiments.

Example Embodiment 1: A process for adjusting calibration of an electronic control unit (ECU) of a powertrain system, the ECU including a microcontroller including a volatile memory and a core, the core including a nonvolatile core memory, a volatile core memory, and a processor, the processor being in operative communication with the nonvolatile core memory, the volatile core memory, and the volatile memory, the nonvolatile core memory configured to store a first value of a first calibration parameter, the process comprising: first operating the ECU to control operation of the powertrain system, the first operating including executing by the processor a control operation using the first value of the first calibration stored in the nonvolatile core memory and a first run time value stored in the volatile core memory; receiving a tuning message from a tool external to the ECU, the tuning message including a tuning value directed to the first value of the first calibration parameter stored in the nonvolatile core memory, the tuning value differing from the first value; redirecting the tuning value to the volatile memory, storing the tuning value in the volatile memory, and second operating the ECU to control operation of the powertrain system, the second operating including second executing by the processor the control operation using the tuning value stored in the volatile memory and a second run time value stored in the volatile core memory.

Example Embodiment 2: The process of Example Embodiment 1, wherein the first value of the first parameter stored in the nonvolatile core memory is unchanged by the second operating.

Example Embodiment 3: The process of Example Embodiment 1, wherein the second executing by the processor includes: requesting by the processor a value of the first calibration stored in the nonvolatile core memory, and redirecting the requesting to the volatile memory to obtain by the processor the tuning value stored in the volatile memory.

Example Embodiment 4: The process of claim 1, wherein: the microcontroller incudes a second core including a second nonvolatile core memory, a second volatile core memory, and a second processor, the second processor being in operative communication with the second nonvolatile core memory, the second volatile core memory, and the volatile memory, the second nonvolatile core memory configured to store a second value of a second calibration parameter; and the first operating includes executing with the second processor a second control operation using the second value of the second calibration parameter stored in the second nonvolatile core memory and a run time value stored in the second volatile core memory.

Example Embodiment 5: The process of claim Example Embodiment 4, wherein: the tuning message includes a second tuning value directed to the second value of the second calibration parameter stored in the second core nonvolatile memory, the second tuning value differing from the second value; and the process further comprises second redirecting the second tuning value to the volatile memory and storing the second tuning value in the volatile memory.

Example Embodiment 6: The process of claim Example Embodiment 5, wherein: the second operating includes executing with the second processor the second control operation using the second value of the second calibration parameter stored in the second nonvolatile core memory and a second run time value stored in the second volatile core memory.

Example Embodiment 7: The process of claim 1, comprising: prior the first operating, bootloading to the nonvolatile core memory a plurality of values of a plurality of calibration parameters of a calibration image, the plurality of values including the first value, and the plurality of calibration parameters including the first calibration parameter.

Example Embodiment 8: An electronic control unit (ECU) for a powertrain system, the ECU comprising: a microcontroller including a volatile memory and a core, the core including a nonvolatile core memory, a volatile core memory, and a processor, the processor being in operative communication with the nonvolatile core memory, the volatile core memory, and the volatile memory, the nonvolatile core memory configured to store a first value of a first calibration parameter; and an interface operatively coupled with the microcontroller and adapted to receive calibration communications from a calibration tool external to the ECU; wherein the ECU is configured to: control operation of the powertrain system by first executing a control operation with the processor using the first value of the first calibration parameter stored in the nonvolatile core memory and a first run time value stored in the volatile core memory, receive with the interface a tuning message including a tuning value directed to the first value of the first calibration parameter stored in the nonvolatile core memory, the tuning value differing from the first value, redirect the tuning value to be stored by the volatile memory, and in response to the tuning message, control operation of the powertrain system by second executing the control operation with the processor using the tuning value stored in the volatile memory and a second run time value stored in the second volatile core memory.

Example Embodiment 9: The ECU of Example Embodiment 8, wherein the first value of the first parameter stored in the nonvolatile core memory is unchanged in response to the tuning message.

Example Embodiment 10: The ECU of Example Embodiment 8, wherein the second executing the control operation with the processor includes: requesting by the processor a value of the first calibration stored in the nonvolatile core memory, and redirecting the requesting to the volatile memory to obtain by the processor the tuning value stored in the volatile memory.

Example Embodiment 11: The ECU of Example Embodiment 8, wherein: the microcontroller incudes a second core including a second nonvolatile core memory, a second volatile core memory, and a second processor, the second processor being in operative communication with the second nonvolatile core memory, the second volatile core memory, and the volatile memory, the second nonvolatile core memory configured to store a second value of a second calibration parameter; and the ECU is configured to control operation of the powertrain system by executing with the second processor a second control operation using the second value of the second calibration parameter stored in the second nonvolatile core memory and a run time value stored in the second volatile core memory.

Example Embodiment 12: The ECU of Example Embodiment 11, wherein: the tuning message includes a second tuning value directed to the second value of the second calibration parameter stored in the second core nonvolatile memory, the second tuning value differing from the second value; and the ECU is configured to second redirect the second tuning value to be stored by the volatile memory.

Example Embodiment 13: The ECU of Example Embodiment 12, wherein: the ECU is configured to control operation of the powertrain system by executing the control operation with the processor using the tuning value stored in the volatile memory and a second run time value stored in the second volatile core memory, and the ECU is configured to control operation of the powertrain system by second executing with the second processor the second control operation using the second tuning value stored in the volatile memory and a second run time value stored in the second volatile core memory.

Example Embodiment 14: The ECU of Example Embodiment 8, comprising: a bootloader configured to load to the nonvolatile core memory a plurality of values of a plurality of calibration parameters of a calibration image, the plurality of values including the first value, and the plurality of calibration parameters including the first calibration parameter.

Example Embodiment 15: A system for controlling operation of a powertrain, the system comprising: an electronic control unit (ECU) including a microcontroller including a volatile memory and a core, the core including a nonvolatile core memory, a volatile core memory, and a processor, the processor being in operative communication with the nonvolatile core memory, the volatile core memory, and the volatile memory, the nonvolatile core memory configured to store a first value of a first calibration parameter and an interface operatively coupled with the microcontroller and adapted to receive calibration communications from a calibration tool external to the ECU, the ECU being configured to perform the acts of: first operating to control operation of the powertrain system, the first operating including executing by the processor a control operation using the first value of the first calibration stored in the nonvolatile core memory and a first run time value stored in the volatile core memory; receiving via the interface a tuning message including a tuning value directed to the first value of the first calibration parameter stored in the nonvolatile core memory, the tuning value differing from the first value; storing the tuning value in the volatile memory, and second operating to control operation of the powertrain system, the second operating including second executing by the processor the control operation using the tuning value stored in the volatile memory and a second run time value stored in the volatile core memory.

Example Embodiment 16: The system of Example Embodiment 15, wherein the second executing by the processor includes: requesting by the processor a value of the first calibration stored in the nonvolatile core memory, and redirecting the requesting to the volatile memory to obtain by the processor the tuning value stored in the volatile memory.

Example Embodiment 17: The system of Example Embodiment 15, wherein: the microcontroller incudes a second core including a second nonvolatile core memory, a second volatile core memory, and a second processor, the second processor being in operative communication with the second nonvolatile core memory, the second volatile core memory, and the volatile memory, the second nonvolatile core memory configured to store a second value of a second calibration parameter; and the first operating includes executing with the second processor a second control operation using the second value of the second calibration parameter stored in the second nonvolatile core memory and a run time value stored in the second volatile core memory.

Example Embodiment 18: The system of Example Embodiment 17, wherein: the tuning message includes a second tuning value directed to the second value of the second calibration parameter stored in the second core nonvolatile memory, the second tuning value differing from the second value; and the ECU is further configured to perform the act of storing the second tuning value in the volatile memory.

Example Embodiment 19: The system of Example Embodiment 18, wherein: the second operating includes executing with the second processor the second control operation using the second value of the second calibration parameter stored in the second nonvolatile core memory and a second run time value stored in the second volatile core memory.

Example Embodiment 20: The system of Example Embodiment 18, further comprising a prime mover operatively coupled with the ECU.

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to a number of acts, configurations, devices, operations, and techniques including, without limitation, calculation or computation of a parameter or value, obtaining a parameter or value from a lookup table or using a lookup operation, receiving parameters or values from a datalink or network communication, receiving an electronic signal (e.g., a voltage, SENT, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A process for adjusting calibration of an electronic control unit (ECU) of a powertrain system, the ECU including a microcontroller including a volatile memory and a core, the core including a nonvolatile core memory, a volatile core memory, and a processor, the processor being in operative communication with the nonvolatile core memory, the volatile core memory, and the volatile memory, the nonvolatile core memory configured to store a first value of a first calibration parameter, the process comprising:
first operating the ECU to control operation of the powertrain system, the first operating including executing by the processor a control operation using the first value of the first calibration stored in the nonvolatile core memory and a first run time value stored in the volatile core memory;
receiving a tuning message from a tool external to the ECU, the tuning message including a tuning value directed to the first value of the first calibration parameter stored in the nonvolatile core memory, the tuning value differing from the first value;
redirecting the tuning value to the volatile memory,
storing the tuning value in the volatile memory, and
second operating the ECU to control operation of the powertrain system, the second operating including second executing by the processor the control operation using the tuning value stored in the volatile memory and a second run time value stored in the volatile core memory.

2. The process of claim 1, wherein the first value of the first parameter stored in the nonvolatile core memory is unchanged by the second operating.

3. The process of claim 1, wherein the second executing by the processor includes:
requesting by the processor a value of the first calibration stored in the nonvolatile core memory, and
redirecting the requesting to the volatile memory to obtain by the processor the tuning value stored in the volatile memory.

4. The process of claim 1, wherein:
the microcontroller incudes a second core including a second nonvolatile core memory, a second volatile core memory, and a second processor, the second processor being in operative communication with the second nonvolatile core memory, the second volatile core memory, and the volatile memory, the second nonvolatile core memory configured to store a second value of a second calibration parameter; and
the first operating includes executing with the second processor a second control operation using the second value of the second calibration parameter stored in the second nonvolatile core memory and a run time value stored in the second volatile core memory.

5. The process of claim 4, wherein:
the tuning message includes a second tuning value directed to the second value of the second calibration parameter stored in the second core nonvolatile memory, the second tuning value differing from the second value; and
the process further comprises second redirecting the second tuning value to the volatile memory and storing the second tuning value in the volatile memory.

6. The process of claim 5, wherein:
the second operating includes executing with the second processor the second control operation using the second value of the second calibration parameter stored in the second nonvolatile core memory and a second run time value stored in the second volatile core memory.

7. The process of claim 1, comprising:
prior the first operating, bootloading to the nonvolatile core memory a plurality of values of a plurality of calibration parameters of a calibration image, the plurality of values including the first value, and the plurality of calibration parameters including the first calibration parameter.

8. An electronic control unit (ECU) for a powertrain system, the ECU comprising:
a microcontroller including a volatile memory and a core, the core including a nonvolatile core memory, a volatile core memory, and a processor, the processor being in operative communication with the nonvolatile core memory, the volatile core memory, and the volatile memory, the nonvolatile core memory configured to store a first value of a first calibration parameter; and
an interface operatively coupled with the microcontroller and adapted to receive calibration communications from a calibration tool external to the ECU;
wherein the ECU is configured to:
control operation of the powertrain system by first executing a control operation with the processor using the first value of the first calibration parameter stored in the nonvolatile core memory and a first run time value stored in the volatile core memory,
receive with the interface a tuning message including a tuning value directed to the first value of the first calibration parameter stored in the nonvolatile core memory, the tuning value differing from the first value,
redirect the tuning value to be stored by the volatile memory, and
in response to the tuning message, control operation of the powertrain system by second executing the control operation with the processor using the tuning value stored in the volatile memory and a second run time value stored in the second volatile core memory.

9. The ECU of claim 8, wherein the first value of the first parameter stored in the nonvolatile core memory is unchanged in response to the tuning message.

10. The ECU of claim 8, wherein the second executing the control operation with the processor includes:
requesting by the processor a value of the first calibration stored in the nonvolatile core memory, and
redirecting the requesting to the volatile memory to obtain by the processor the tuning value stored in the volatile memory.

11. The ECU of claim 8, wherein:
the microcontroller incudes a second core including a second nonvolatile core memory, a second volatile core memory, and a second processor, the second processor being in operative communication with the second nonvolatile core memory, the second volatile core memory, and the volatile memory, the second nonvolatile core memory configured to store a second value of a second calibration parameter; and
the ECU is configured to control operation of the powertrain system by executing with the second processor a second control operation using the second value of the second calibration parameter stored in the second nonvolatile core memory and a run time value stored in the second volatile core memory.

12. The ECU of claim 11, wherein:
the tuning message includes a second tuning value directed to the second value of the second calibration parameter stored in the second core nonvolatile memory, the second tuning value differing from the second value; and
the ECU is configured to second redirect the second tuning value to be stored by the volatile memory.

13. The ECU of claim 12, wherein:
the ECU is configured to control operation of the powertrain system by executing the control operation with the processor using the tuning value stored in the volatile memory and a second run time value stored in the second volatile core memory, and
the ECU is configured to control operation of the powertrain system by second executing with the second processor the second control operation using the second tuning value stored in the volatile memory and a second run time value stored in the second volatile core memory.

14. The ECU of claim 8, comprising:
a bootloader configured to load to the nonvolatile core memory a plurality of values of a plurality of calibration parameters of a calibration image, the plurality of values including the first value, and the plurality of calibration parameters including the first calibration parameter.

15. A system for controlling operation of a powertrain, the system comprising:
an electronic control unit (ECU) including a microcontroller including a volatile memory and a core, the core including a nonvolatile core memory, a volatile core memory, and a processor, the processor being in operative communication with the nonvolatile core memory, the volatile core memory, and the volatile memory, the nonvolatile core memory configured to store a first value of a first calibration parameter and an interface operatively coupled with the microcontroller and adapted to receive calibration communications from a calibration tool external to the ECU, the ECU being configured to perform the acts of:
first operating to control operation of the powertrain system, the first operating including executing by the processor a control operation using the first value of the first calibration stored in the nonvolatile core memory and a first run time value stored in the volatile core memory;
receiving via the interface a tuning message including a tuning value directed to the first value of the first calibration parameter stored in the nonvolatile core memory, the tuning value differing from the first value;
storing the tuning value in the volatile memory, and
second operating to control operation of the powertrain system, the second operating including second executing by the processor the control operation using the tuning value stored in the volatile memory and a second run time value stored in the volatile core memory.

16. The system of claim 15, wherein the second executing by the processor includes:
requesting by the processor a value of the first calibration stored in the nonvolatile core memory, and
redirecting the requesting to the volatile memory to obtain by the processor the tuning value stored in the volatile memory.

17. The system of claim 15, wherein:
the microcontroller incudes a second core including a second nonvolatile core memory, a second volatile core memory, and a second processor, the second processor being in operative communication with the second nonvolatile core memory, the second volatile core memory, and the volatile memory, the second nonvolatile core memory configured to store a second value of a second calibration parameter; and
the first operating includes executing with the second processor a second control operation using the second value of the second calibration parameter stored in the second nonvolatile core memory and a run time value stored in the second volatile core memory.

18. The system of claim 17, wherein:
the tuning message includes a second tuning value directed to the second value of the second calibration parameter stored in the second core nonvolatile memory, the second tuning value differing from the second value; and
the ECU is further configured to perform the act of storing the second tuning value in the volatile memory.

19. The system of claim 18, wherein:
the second operating includes executing with the second processor the second control operation using the second value of the second calibration parameter stored in the second nonvolatile core memory and a second run time value stored in the second volatile core memory.

20. The system of claim 18, further comprising a prime mover operatively coupled with the ECU.
